(19) United States
(12) Patent Application Publication
(10) Pub. No.: US 2003/0144016 A1
(43) Pub. Date: Jul. 31, 2003

(54) System and method for object access through an access device

(76) Inventors: Amir Kolsky, Binyamina (IL); Eran Fine, Givataiim (IL)

Correspondence Address: Antonhy Castorina, GE Ehrlich (1995) Ltd, Suite 207, 2001 Jefferson Davis Highway, Arlington, VA, 22202, US

(21) Appl. No.: 10/311,585

(22) PCT Filed: Jun. 19, 2001
(86) PCT No.: PCT/IL01/00557

(51) Int. Cl. H04B 7/00

(52) U.S. Cl. 455/517; 455/219

(57) ABSTRACT

A system and a method for object access through a cellular telephone, which is termed herein “object dialing”. Object dialing requires a data enabled access device, such as a cellular telephone for example, through which the user enters an object identifier. The cellular telephone then connects to a object identifier resolution server, which processes the object identifier. The process of connection is optionally performed by initializing a voice telephone call which is then automatically switched to a data connection call, and alternatively or additionally is performed with manual interaction from the user. Also alternatively or additionally, the process of connection is initialized through the transmission of a data message, such as an SMS message for example, after which the connection may again be alternatively or additionally performed with manual interaction from the user.

### FIELD OF THE INVENTION

The present invention relates to the areas of telecommunication and information networks. In particular, the present invention provides a method and system for allowing universal access to heterogeneous resources through a cellular telephone or other access device.

### BACKGROUND OF THE INVENTION

In recent years the diversity and functionality of telecommunication networks has evolved dramatically into a landscape of heterogeneous networks each being associated with a diverse array of heterogeneous resources. In particular, the diversity of available resources and the associated networks on which the reside eclipses the notion of a single traditional voice communications network utilizing circuit switching such as the PSTN (“Public Switched Telephone Network”). Instead, the PSTN emerges as merely one network entity amidst a sea of heterogeneous networks Today the functionality of telecommunications extends far beyond a simple notion of point-to-point voice calls to the concept of a complex structure of heterogeneous information networks each being associated with a myriad of resources.

Moreover, information network users are equipped with a variety of access devices that may support various capabilities including voice, audio, data and text, as well as multimedia capabilities. Some of these devices may support multi-mode communications, which allow, for example data access as well as voice communications (e.g., recent introduction of cellular telephones with Web access).

Furthermore, modern telecommunications users have come to rely on the services and functionality provided by these diverse information networks. For example, today users depend on the Internet and Web as heavily as they have on the PSTN.

However, despite the enhanced potential of modern communications networks, access to resources is often restricted in that a user must access a particular resource utilizing an information network with which that resource is associated. Thus, for example, if a user desires to access a Web page, the user must utilize an access device that connects to the Internet and Web. Similarly, do dial a telephone number, a user must utilize an access device that connects to the PSTN. Moreover, in order to access a particular resource, a user must be equipped with an access device that can communicate utilizing the protocols and access methods associated with the resource. Furthermore, users are required to be fluent in a myriad of network protocols and network addressing schemes. For example, if a user desires to access a resource on the Internet, the user must remember a particular URL associated with the resource. On the other hand, using the PSTN, the user must remember a particular telephone number associated with a resource. Resources are associated with networks in that they are accessible only via certain networks. Any resource can be addressed.

Each available information network is associated with a particular access method and access device. For example, the PSTN relies upon a telephone access device. Users access resources by through an access method of dialing. On the other hand, when utilizing a network such as the Internet and Web users are forced to adapt to the idiosyncratic access methods associated with the Web (i.e., a browser and HTTP (“Hypertext Transport Protocol”)) in order to access resources residing there. In addition, users take for granted that they are forced to rely upon a specific access device (typically a computer), which carries its own intrinsic interaction mechanism (typically a keyboard and mouse). Although Web-enabled wireless telephones have been introduced, these devices are essentially multimode devices that incorporate a wireless telephone with a processor running a stripped down browser. With these devices, users are nevertheless required to adapt to the Web environment and associated access methods (i.e., a browser and HTTP).

The evolving nature of telecommunication networks has resulted in a growing reliance by modern telecommunications users on access to a diverse and flexible variety of resources in order to effectively work and communicate. Resources may include data, processes and services accessible to users, which facilitate the exchange of information, methods for access to information or the substantive nature of the information itself. The concept of a resource as it relates to modern information networks is constantly evolving and only limited by the imagination of network architects and telecommunication engineers.

Thus, for example, resources include new types of data and media accessible to users, which may have been inaccessible using conventional telecommunication networks such as the PSTN including video or still frame images.

FIG. 1 depicts a relationship between a number information networks and corresponding access devices. In particular, FIG. 1 depicts information networks 112(1)-112(N), each of which may respectively be accessed via corresponding network interface 120(1)-120(N) and network device 102(1)-102(N). Note, although FIG. 1 depicts only a single access device per information network, each particular information network 112(1)-112(N) may be associated with a plurality of network devices 102 for accessing resources on the network.

Referring to FIG. 1, information network 112(1) (which might be the PSTN, for example) is associated with network interface 120(1) (which might be an SSP node) and network device 102(1) (which might be, for example, a conventional telephony device). Information network 112(2) (which might be the Internet and Web, for example) is associated with network interface 120(2) (which might be an ISP) and network device 102(2) (which might be a computing device such as a personal computer).

Similarly, access networks 112(3)-112(N) would be accessible via corresponding network interfaces 120(3)-120(N) and access devices 102(3)-102(N). Note that each information network 112(1)-112(N) is respectively associated with a plurality of resources, 105(11)-105(1N)-105(N1)-105(NN). Resources are typically associated with a network by virtue of the fact that a user would utilize the associated network and associated protocols for the network to access the resource. For example, HTML pages are typically associated with the Internet/Web, by virtue of the fact that users typically access HTML pages via protocols associated with the Internet/Web (namely, HTTP and TCP/IP). Effectively, information networks 112(1)-112(N) respectively function as access networks for resources associated with those networks (i.e., resources 105(12)-105(1N)-105(N1)-105(NN)) in that these networks allow a user to access those respective resources.

Using conventional technology, a user may only access only those resources associated with an access network which is in direct communication with the particular desired resources. For example, in the case where the access network is the PSTN and the access network device is a telephone device, typically the telephone device may only obtain access only to physical or virtual voice communication channels (in some cases circuit switched, in other packet based) within the PSTN. Utilizing the PSTN and a telephone device, access to an HTML page residing on an Web server would not be possible using access methods associated with a telephone device (namely dialing).

Although multimode access devices do exist (e.g., a WAP enabled cellular telephone), which may provide access to resources on heterogeneous networks (i.e., the PSTN and the Internet/Web), to access resources associated with different networks requires utilization of an access method and network address for the resource that is specific to the particular network being accessed. For example, if a user of WAP enabled telephone desires to initiate a WAP session with a desired resource such as an HTML page on the Internet/Web, the user must first switch the cellular phone into a WAP/data mode. Then, the user must enter a URL associated with the HTML page using the HTTP protocol. Thus, there does not exist a universal mechanism for access to resources associated with heterogeneous networks from any network.

FIGS. 2a-2b illustrate two exemplary networks that may operate in conjunction with the present invention. In particular, FIG. 2a depicts a block diagram of an SS7 (“Signaling System 7”) network while FIG. 2b depicts a block diagram of the Internet/Web.

FIG. 2a is a block diagram of elements within an SS7 network. In particular, FIG. 2a depicts two interconnected SS7 networks 214(1) and 214(2). SS7 networks 214(1)-214(2) may include one or more of the following elements SSP (“Signaling Switching Points”) 201(1)-201(4) nodes, STP (“Signaling Transfer Point”) 212(1)-212(4) nodes and SCP (“Signaling Control Point”) nodes 202(1)-202(4). Note that the exemplary SS7 networks 214(1)-214(2) shown in FIG. 2a depicts four SSP nodes 201(1)-201(4), four STP nodes 212(1)-212(4) and four SCP nodes 202(1)-202(4). However, an SS7 network may include any number or combination of these elements. SSP nodes 201(1)-201(4) are telephone switches (end offices or tandems) equipped with SS7-capable software and terminating signaling links. SSP nodes 201(1)-201(4) originate, terminate or switch calls. STPs 212(1)-212(4) provide packet switching functions, receiving and routing incoming signaling messages toward a proper destination as well as specialized routing functions. SCP nodes 202(1)-202(4) are databases that provide information necessary for advanced call-processing capabilities. Note that SSP nodes 201(1)-201(4), STP nodes 212(1)-212(4) and SCTP nodes 202(1)-202(4) are coupled together via signaling links 243. SSP nodes 201(1)-201(4) are coupled together via voice trunks 245.

FIG. 2a also depicts a plurality of access devices 102(1)-102(6), in this case telephony devices, that are coupled to SSP nodes 201(1)-201(4) via subscriber lines 247.

FIG. 2b is a block diagram that depicts the topology of the Internet/Web.

### SUMMARY OF THE INVENTION

The background art does not teach or suggest a system and a method for object access through a cellular telephone. The background art also does not teach or suggest such a system or method in which a subscriber receives interactive data transmissions by entering an identifier into the cellular telephone.

The present invention overcomes these deficiencies of the background art by providing a system and a method for object access through a cellular telephone, which is termed herein “object dialing”. Object dialing requires a data enabled access device, preferably a cellular telephone, through which the user enters an object identifier. The cellular telephone then connects to a object identifier resolution server, which processes the object identifier. Once the connection has been initiated, the server processes the object identifier in order to locate the requested object. After the server identifies the object, then preferably at least one interactive communication is sent to the cellular telephone of the user. For example, such an interactive communication could optionally be a menu, from which the user selects one or more choices, and/or enters additional data.

Optionally and preferably, the cellular telephone is WAP-enabled, or otherwise Web page enabled, to receive data, for example Web pages, images and so forth. Alternatively or additionally, the cellular telephone can be capable of SMS (short message service) communication. Also alternatively or additionally, the cellular telephone could optionally be an iMode device or TCP/IP, GPRS, wCDMA or G3 telephone device (wCDMA and G3 are the next generation cellular networks, GPRS is “General Packet Radio System” which is a packet-based cellular network).

According to other optional embodiments of the present invention, a request string is sent from the cellular telephone of the user as one of a regular telephone number, an application invocation according to USSD, or a SMS (short message service) message. Of course other embodiments for requesting the information object, such as a Web page, can also optionally be implemented (alternatively or additionally to these previously described methods).

According to the present invention, there is provided a method for providing access to a resource through an access network with an access device, comprising: associating the resource with an object identifier; transmitting a request with the object identifier to access the resource with the access device through the access network; resolving the request to identify the resource according to the object identifier; and accessing the resource with the access device if the request is resolved.

Hereinafter, the term “network” refers to a connection between any two or more devices which permits the transmission of data. Examples of networks include, but are not limited to, PSTN (public switched telephone network), data networks, and networks for computational devices.

Hereinafter, the term “computational device” includes any type of device which is capable of performing computations, including but not limited to, hand-held computers. PDA (personal data assistant) devices, cellular telephones, any type of WAP (wireless application protocol) enabled device, wearable computers of any sort, and any device which can be connected to a network as previously defined and which has an operating system.

Hereinafter, the term “cellular telephone” refers to any type of wireless or cordless device which is capable of data transfer through a radio frequency signal, optionally through a connection to the PSTN (public switched telephone network).

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof. For any of these implementations, the functions performed by the method could be described as a plurality of instructions performed by a data processor.

### BRIEF DESCRIPTION OF THE DRAWINGS

The invention is herein described, by way of example only, with reference to the accompanying drawings, wherein:

FIG. 1 depicts a relationship between information networks and corresponding access devices.

FIG. 2a is a block diagram of elements within an SS7 network.

FIG. 2b is a block diagram that depicts a topology of the Internet/WWW.

FIG. 3 is a schematic block diagram of an exemplary system according to the present invention;

FIG. 4 is a flowchart of an exemplary method according to the present invention; and

FIGS. 5A-5D are workflow diagrams of four exemplary connection methods according to the present invention.

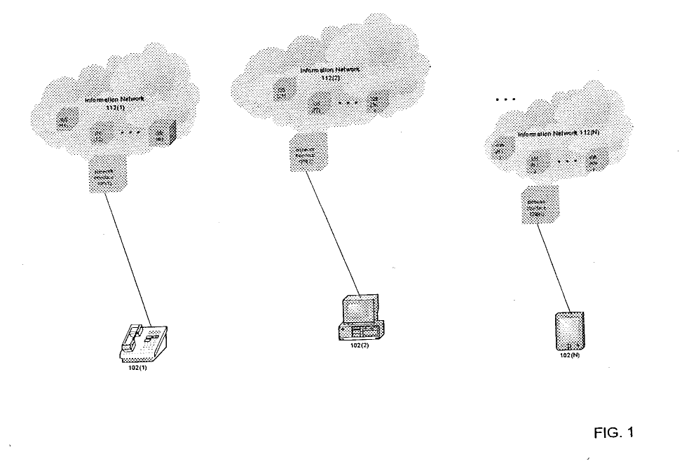

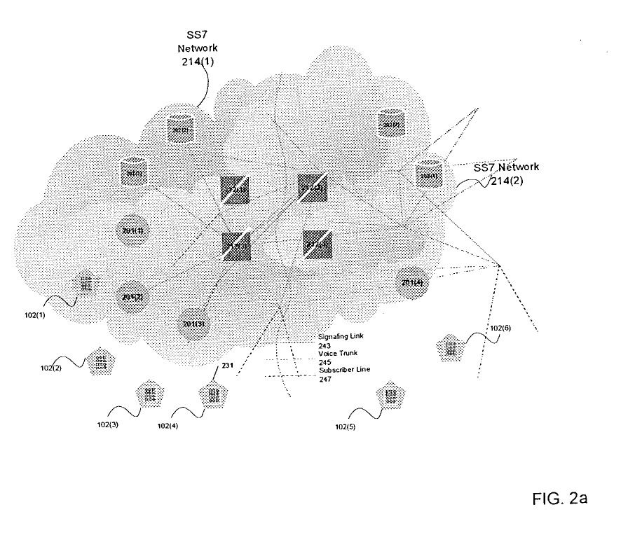

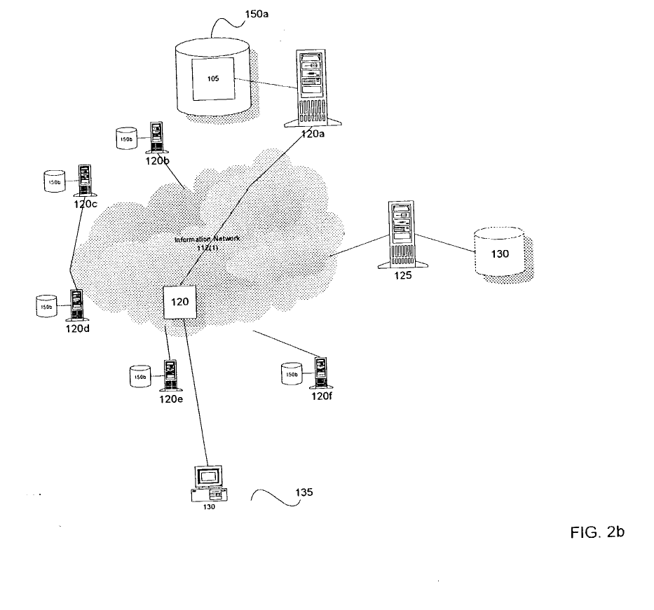

### DESCRIPTION OF THE PREFERRED EMBODIMENTS

The present invention is of a system and a method for object access through a cellular telephone, which is termed herein “object dialing”. Object dialing requires a data enabled access device, such as a cellular telephone for example, through which the user enters an object identifier. The cellular telephone then connects to a object identifier resolution server, which processes the object identifier. The process of connection is optionally performed by initializing a voice telephone call which is then automatically switched to a data connection call, and alternatively or additionally is performed with manual interaction from the user. The object identifier is used to locate and/or identify a resource. Resources may include data or services of any form including, but not limited to, text, video audio, commerce, information services, and so forth.

Also alternatively or additionally, the process of connection is initialized through the transmission of a data message, such as an SMS message for example, after which the connection may again be alternatively or additionally performed with manual interaction from the user.

The process of manual interaction is more preferably performed by preparing the data connection call after the initial communication has been performed by the user, but then requiring the user to actually cause the switch to the data connection call to occur. Alternatively, the manual interaction requires addressing information such as a URL to be submitted after manually initializing a connection to a WAP gateway or other data resource.

Once the connection has been initiated, the server processes the object identifier in order to locate the requested object. Preferably, the object identifier is interpreted according to the telephone number which has been dialed through the cellular telephone, and optionally is further interpreted by including the identity and physical location of the user, and the characteristics and/or capabilities of the cellular telephone or other access device of the user.

Also optionally and preferably, the software, hardware and/or firmware of the cellular telephone could be enabled to automatically interpret a particular object identifier and/or object code, such that the cellular telephone would automatically initiate a data connection session with the server. According to this embodiment, information in the form of a request string is preferably sent to the cellular telephone provider. The string may optionally be in the form of a telephone number, preferably with a predetermined prefix(es), which is then entered and sent as for a regular voice telephone call. However, more preferably no voice communication is required, as a Web page or other information object is returned according to the request string, most preferably either automatically or with a manual acceptance by the user.

According to another optional embodiment, the string is in the form of an application invocation through USSD (unstructured supplementary services data) format. This format causes an application to be invoked, rather than causing the receiving server to resolve the entered string as a telephone number. According to yet another optional embodiment, the request string is sent as an SMS message,

After the server identifies the object, then preferably at least one interactive communication is sent to the cellular telephone of the user. For example, such an interactive communication could optionally be a menu, from which the user selects one or more choices, and/or enters additional data. As another example, a Web page could optionally be returned to the cellular telephone.

In another embodiment of the present invention, a class of resources call Universal Shell Objects (USO) is defined. USO's are identified by object identifiers. USOs serve as anchor points for arbitrary services, which are said to be associated with the USO. These services may effect the delivery of goods of information. Users connect to USOs to interact with these services in what is called a transaction. Once an object identifier is resolved to a USO, the USO is optionally and preferably provided with data pertaining to the user, such as user classification, preferences, capabilities, permissions, security and authentication data, personal and demographic data and profiling information; device information, such as which access network was used to enter the object identifier, device capabilities and limitations, bearer capabilities and routing information; contextual information, such as device or user location, locale information such as language, temporal information such as the time or any other external information, such as market index values or the fact that some event had occurred or not. The collection of information is called the environment of the transaction.

Based on this information, USOs need to determine what the correct action to be performed is. In order to do so, they confer with all services which are anchored to them. These services may be anchored on a specific USO level or at a higher USO class level. More than one USOs may be involved in a transaction. In that case, the services associated with all these USOs may be consulted.

The transaction is sent to all the services associated with the USO along with the transaction environment. Each service is given the chance to influence the final outcome of the request. The responses from these services can cause other services to be consulted, some action to be performed, some information to be presented to the user, via audio, visual or tactile means, screens to constructed or lists of options to be presented to the user. For example, a user connecting to some object identifier may be sent an SMS message with some information in it; be presented with a menu of available options or have some specific action performed, or a combination thereof.

The USO preferably defines the interfaces and metadata that is required of services so that they can be presented to the user if needed, consulted on transactions and then invoked if selected by the user. Management interfaces more preferably exist to create, destroy and otherwise manage the lifecycle of USOs, associate services with USOs, configure the services associated with USOs, define presentation formats for different access channels and capabilities, define USO classes and objects and any special USO behavior as well as manage access permissions and association of object identifiers with USOs.

According to preferred embodiments of the present invention, one or more delivery mechanisms are provided for disseminating object identifiers to potential users. The object identifier is optionally and preferably disseminated to users through various delivery mechanisms, including but not limited to television, newspapers, books, magazines and other printed material, billboards, music videos, currency, labels, cinema and movie presentations, the Internet and Web, banners, and so forth. The possible types of delivery mechanisms for object identifiers are virtually inexhaustible. For example, object identifiers could optionally be embedded in any type of commercial product for accessing critical information related to the product. For example, if the product is a medication, an object identifier could optionally be embedded on the label of the application such that when submitted by a user, information related to the medication would be available to the user using a variety of access devices. An object identifier could even optionally be embedded on a capsule or pill through which the medication is packaged and dispensed.

According to optional but preferred embodiments of the present invention, the object identifiers are assigned by a central authority. Preferably these identifiers are organized in a hierarchical structure, similar to that of telephone numbers. More preferably, each portion of the identifier has a separate scope, which is most preferably determined geographically as for regular telephone numbers. For example, a portion which has a global scope may be seen as similar to the country code of telephone numbers; the country is similar to area codes; the area scope is similar to local exchanges; the exchange scope is similar to subscriber numbers; and the subscriber scope is similar to extension numbers.

The user is optionally able to enter each scope separately, such that different menus and/or other choices are preferably displayed through the cellular telephone or other access device according to the scope which has been entered.

The principles and operation of the present invention may be better understood with reference to the drawings and the accompanying description, it being understood that these drawings are given for illustrative purposes only and are not meant to be limiting.

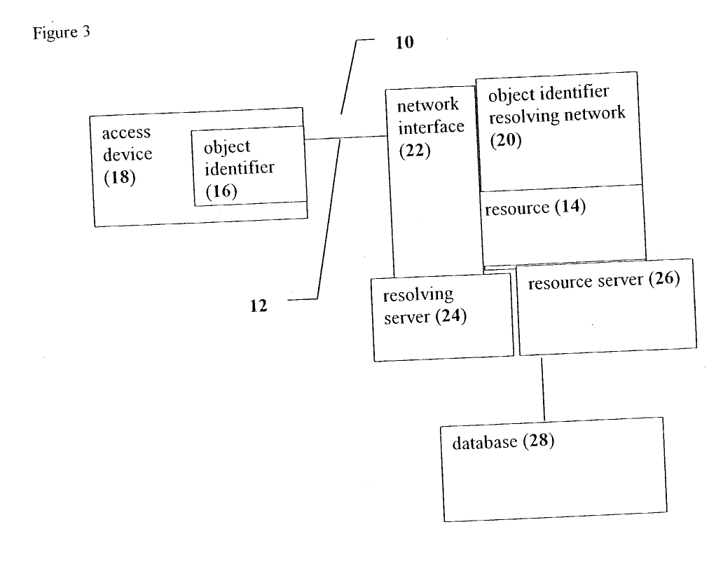

Referring now to the drawings, FIG. 3 is a schematic block diagram of a system for object access through a cellular telephone. For a system 10, a user of an access network 12 may initiate a session with a resource 14 by dialing a corresponding object identifier 16 through access device 18. Such an object identifier could be a telephone number, for example. In this example, access network 12 is preferably a wireless network, although alternatively a different network may be used, including but not limited to, a regular PSTN network, a pager network, an IP telephony network or an ISDN network. Also in this example, access device 18 is preferably a wireless device such as a telephone, although a different device may be used, including but not limited to, a non-wireless telephone, a pager device, a PDA or a Web telephone.

The object identifier is optionally obtained from a display which is in close physical proximity to a physical representation of the object, such as an advertisement for example. Alternatively, the object identifier could be obtained from any other type of display, such as a newspaper or other printed material for example. More preferably, there is no requirement for access device 18 to be in close physical proximity to the physical representation of the object when the object identifier is entered by the user.

Object identifier 16 is received at an object identifier resolving network 20 via access network 12 and a network interface 22. Network interface 22 enables object identifier resolving network 20 to communicate with access device 18 through access network 12. Object identifier resolving network 20 preferably performs functions for resolving object identifiers and performing session establishment.

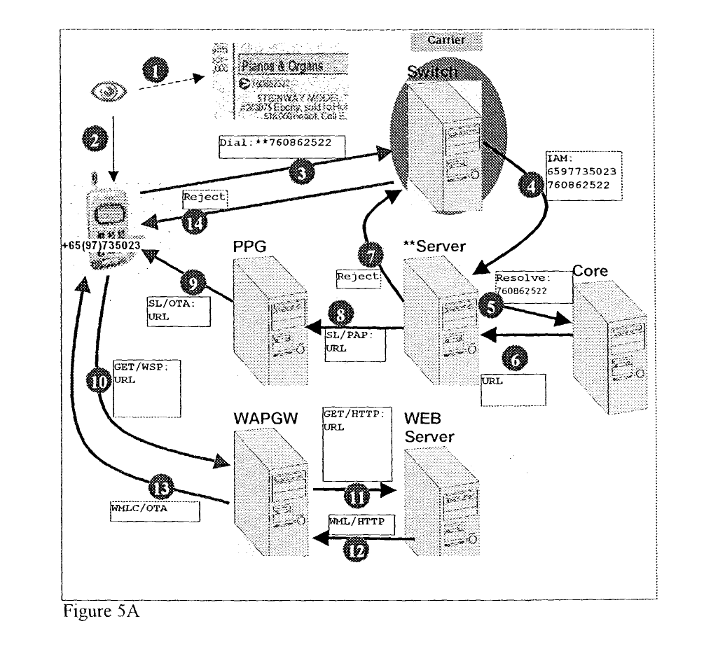

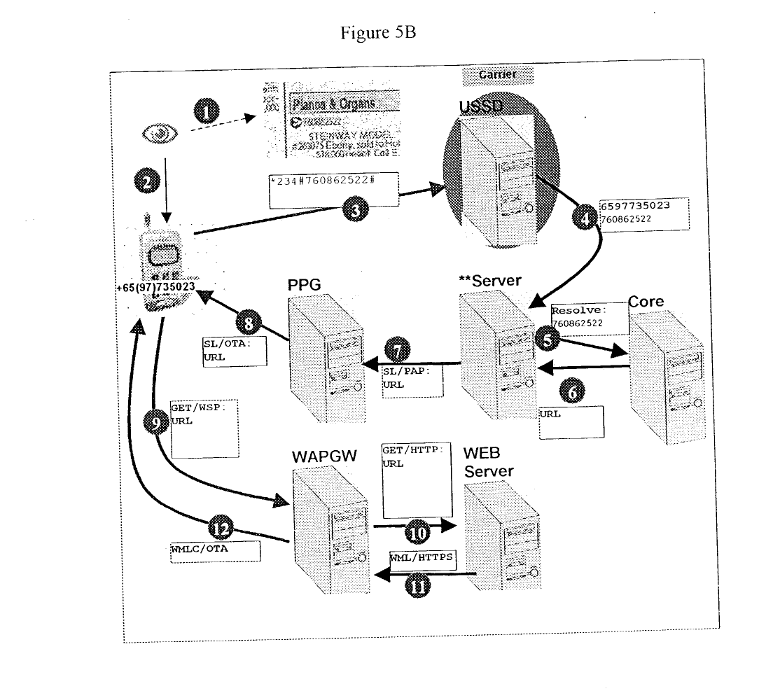

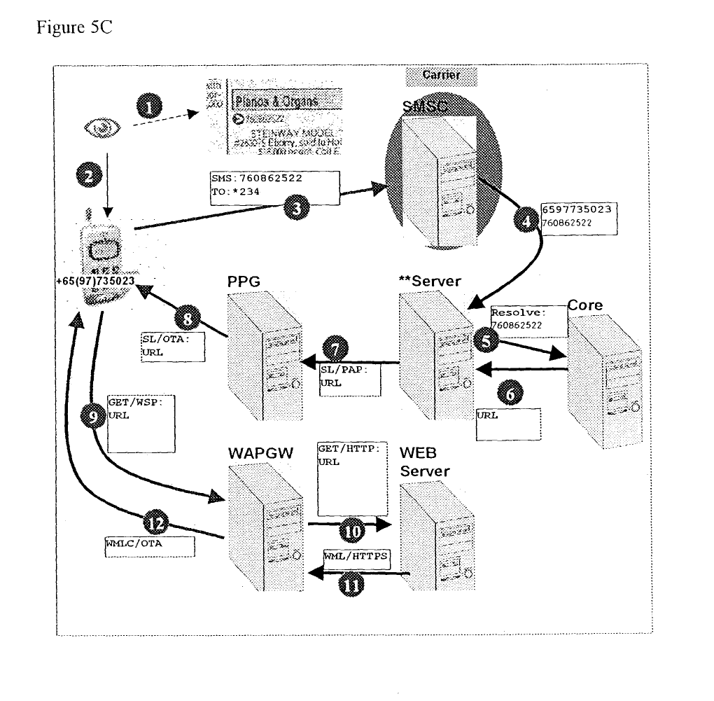

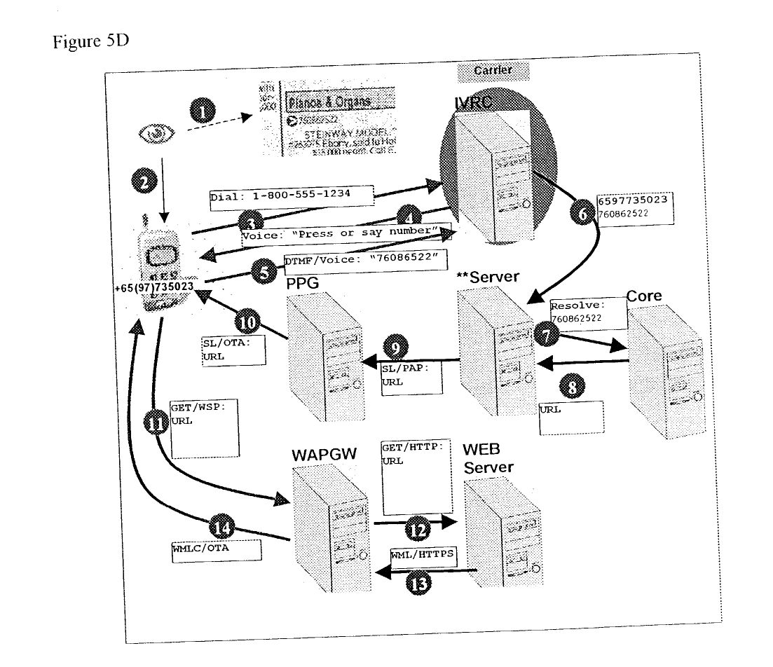

Object identifier resolving network 20 preferably includes at least a resolving server 24 and a resource server 26, as described in greater detail below with regard to FIGS. 5A-5D. Briefly, resolving server 24 preferably resolves the object identifier in order to be able to determine which resource 14 is being requested. Resource 14 is then more preferably accessed through resource server 26. For example, if resource 14 is a Web page, then resource server 26 is preferably a Web server of some type, optionally such as a WAP gateway for example.

Object identifier resolving network 20 preferably features a database 28 for storing information about a plurality of objects, such as rules for identifying the objects and rules for handling communication with the objects, for example.

Also, note that the present invention is compatible and may be implemented with access devices 18 that allow multi-mode capabilities, for example a wireless telephone for communication through a corresponding wireless network, which could also optionally feature Web browser software for communication through the Internet/Web.

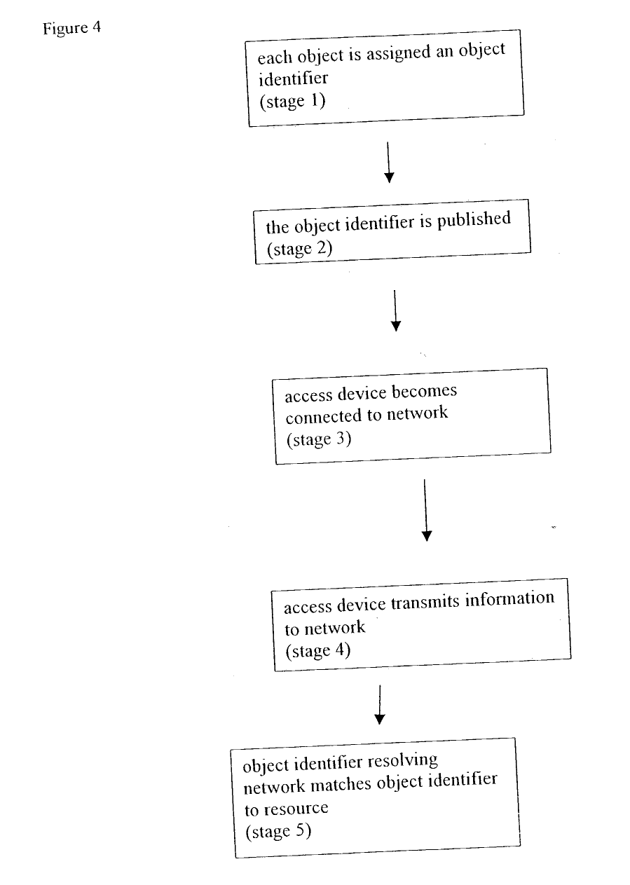

As shown in the flowchart of FIG. 4, in stage 1, each object is assigned an object identifier. The object identifier is optionally a telephone number as previously described. Optionally, a single object could have a plurality of associated object identifiers.

In stage 2, the object identifier is published. Optionally and preferably, the object identifier is published by being placed in close physical proximity to a physical representation of the object.

In stage 3, the access device of the user, such as a cellular telephone, becomes connected to the object identifier resolving network. Next, in stage 4, the access device of the user transmits information to the object identifier resolving network. As described in greater detail below, this information may optionally be in the form of voice data, SMS (short message service) message data, a message in the USSD (unstructured supplementary services data) format, or in any other type of message/data format which is compatible with the particular access device.

In stage 5, the object identifier resolving network matches the object identifier to the requested resource, and transmits information to the access device concerning the resource. Optionally and more preferably, the object identifier resolving network initiates a session with a server for serving the resource. The session is optionally and most preferably manually accepted by the user. Preferably, the session involves the delivery of data to the access device of the user in a different mode than the initial communication of the user with the object identifier resolving network, through “mode switching”. For mode switching, the initial communication of the access device with the object identifier resolving network is performed according to one mode, while the delivery of data from the resource is performed according to a second mode. For example, the initial communication could optionally be through voice data, while the session is then optionally a WAP-based session for delivery of Web pages.

Four exemplary, alternative methods are shown with regard to the workflow diagram of FIGS. 5A-5D. These exemplary methods demonstrate that the method of the present invention is operative with a number of different connection modalities which can be performed through a cellular telephone or other type of access device.

All four methods are initiated at the arrow marked “1”, when the user sees an object identifier, which in this case is a string of numbers which is printed on, or otherwise related to a physical object, in this example a newspaper advertisement. Next, at the arrow marked “2”, the user enters some type of numeric, alphanumeric, or symbol string, or a combination thereof, to the cellular telephone, which is being used herein for the purposes of description only and is without any intention of being limiting. The string could optionally also be entered by voice, and/or through scanning the information, entry of a barcode and so forth.

The four exemplary methods now diverge, with regard to the type of string which is entered, and the further mechanism for returning the desired information to the user.

In FIG. 5A, the arrow which is marked as “3” has the string “**760862522”, which is the string which has been entered by the user. This string is optionally any type of telephone number and/or a string or other information entered with the voice of the user. The user now activates the cellular telephone as though for a voice telephone call. In this example, the prefix “**” acts as an address and indicates that this string should be sent to a particular server, which may optionally be located at the cellular telephone provider. This string is sent to a switch or MSC (mobile service controller), when then resolves the address according to the prefix, and sends the string to the appropriate server at the arrow marked as “4”. This server is labeled “**server”, to indicate that this server is intended to receive strings which are addressed with the prefix“**”.

According to an optional but preferred embodiment of the present invention, the switch resolves the address as for any type of telephone number. For typical cellular telephone operation, both the area code and the actual telephone number are entered. The switch is then able to select the proper PSTN telephone switch for receiving this request according to the area code, according to a mechanism which is known in the art as “global title translation”. Of course, any other prefix-based or other type of number could also optionally be used. For the present invention, this mechanism is optionally and preferably invoked to cause the switch to send the string to a dedicated server, the ** server, as an IAM (initial address message). The top number string, “6597735023”, identifies the cellular telephone which transmitted the initial string. This identifying number may optionally be retrieved according to any type of caller identification (“caller id”) which is associated with the cellular telephone network and/or which is external to the network.

If the identifying number can be determined, then optionally the user is recognized and a unique identifier of the user is preferably returned. If the user is not recognized, then the outcome of the request depends upon the capabilities of the cellular telephone of the user.

Once the **server receives the message (string), this server resolves the message. The server then sends the requested initial string to a core, at the arrow marked as “5”. The core then converts the initial string (object identifier) to the corresponding pointer or address for the resource which has been requested by the user, shown herein as a URL. The core could optionally perform this stage according to a lookup table, for example. The URL is then returned to the **server, with an arrow marked as “6”.

If no URL can be found, or if the returned pointer/address is otherwise rejected, the **server optionally and more preferably sends a “reject” and/or “error” message to the switch at the arrow marked as “7”. More preferably, the **server sends such a “reject” message in order to force the cellular telephone of the user to disconnect. As another option, the **server could detect whether the cellular telephone of the user is capable of receiving a particular type of data, such as a WAP session, which would require mode switching, and would then reject the call in order to force such mode switching to occur. This rejection is returned to the cellular telephone of the user at the arrow marked as “18”.

Otherwise, the **server preferably returns a SL (service load request) message to a PPG (push proxy gateway), at the arrow marked as “8”. An alternative form of this message is a SL message sent through the PAP (push access protocol) protocol.

The PPG then converts this message to a format which is recognizable by the cellular telephone of the user, before sending this message to the cellular telephone at the arrow marked as “9”. More preferably, the message is sent as a SL message which forces the cellular telephone to retrieve the information at the URL or other pointer/address which is contained in the message, by initiating a push session. Alternatively, the SL message is sent as a POTA (protocol over the air) message, which is part of the WAP specification. The user may optionally be requested to retrieve the information at the URL or other pointer/address which is contained in the message, for example with a SI (service indication) message. The message may also optionally and preferably be sent according to a proprietary format.

Regardless of whether the user requests and/or acknowledges the URL, or the cellular telephone is forced to connect to the URL, a GET message is sent by the cellular telephone to the WAP gateway server (WAPGW), shown at the arrow marked “10”, in order to obtain the URL. Therefore, in this example, the WML browser of the cellular telephone of the user preferably establishes a WSP session with the preconfigured WAP gateway server.

Although the WAPGW server is shown as being implemented according to the WAP protocol, the present invention may optionally include any type of HTTP or other mark-up language server.

The WAPGW then sends a GET message according to the HTTP protocol to a Web server according, to the URL, shown at arrow “11”. The Web server then returns either a WvNL page directly, or if the Web server is unable to serve Web pages according to this particular protocol, the Web page is preferably returned according to a protocol such as HTTPS (secure HTTP), shown at arrow “14”. If necessary, WAPGW translates the Web page document into WML or another suitable language for the cellular telephone, and returns this Web page at arrow “15”. Of course, other suitable formats could be used.

FIG. 5B shows another exemplary embodiment of the method according to the present invention, which is similar to the method of FIG. 5A, except that a different protocol is used to transmit the initial string or other information from the cellular telephone. As shown at the arrow marked “3”, the string is now “*234#7760862522#”. The number “7760862522”, which indicates the URL or other address/pointer for the desired information, has not changed. However, the addressing information for that address/pointer has now changed, to the USSD (unstructured supplementary services data) format. This format causes an application to be invoked on the telephone, which establishes the USSD session, rather than causing the dial-up switch to resolve the entered string as a telephone number.

As shown, the string is received by the USSD server at the cellular telephone service provider. The USSD server determines that the **server provides the service identified as “234”, and sends the information to that server at arrow “4”. As shown, preferably both the requested number (7760862522) and the originating telephone number of the cellular telephone of the user (6597735023) are sent to the ** server.

The **server then resolves the requested number, and sends this information to the core server again, at the arrow marked “5”. The remaining stages are performed as described with regard to FIG. 5A.

Yet another exemplary embodiment of the method of the present invention is shown with regard to FIG. 5C. Now the user enters the telephone number (*234) as an SMS message, which is automatically sent to a SMSC (SMS message controller) by the cellular telephone at the arrow marked “3”. As SMS messages are textual messages which are typically sent to a particular telephone number, the SMS message is preferably sent to a number which identifies the relevant server, which in this case is the *234server, so the SMS message is preferably sent to “*234”. The remaining parts of the procedure are performed as described with regard to FIG. 5A.

FIG. 5D shows an interactive voice response (IVR) mechanism for receiving the request for the object identifier from the user through the cellular telephone of the user. At arrow “3”, the user dials a number, shown here as a “800” number, although any type of number could optionally be used. Next, the IVR carrier (IVRC) transmits a request to the cellular telephone of the user at arrow “4”, which is preferably an audio message, to enter the number through the keypad and/or to vocally state the number. At arrow “5”, the telephone number is entered by the audible voice of the user and/or through “DMTF” (dual tone multiple frequency). The remainder of the procedure may then be performed as described with regard to FIG. 5A.

While the invention has been described with respect to a limited number of embodiments, it will be appreciated that many variations, modifications and other applications of the invention may be made.

What is claimed is:

1. A method for providing access to a resource through an access network with an access device, comprising:
associating the resource with an object identifier;
transmitting a request with said object identifier to access the resource with the access device through the access network;
resolving said request to identify the resource according to said object identifier; and
accessing the resource with the access device if said request is resolved.

2. The method of claim 1, wherein said request is transmitted according to a first mode through the access network, while the resource is accessed according to a second mode through the access network, such that accessing the resource causes the access device to switch from said first mode to said second mode.

3. The method of claim 2, wherein the access device is forced to switch from said first mode to said second mode.

4. The method of claim 2, wherein the access device is requested to switch from said first mode to said second mode.

5. The method of any of claims 1-4, wherein resolving said request includes identifying a user of the access device.

6. The method of claim 5, wherein said user is identified for using the access network with a user identification, such that said user is identified when resolving said request with said user identification for the access network.

7. The method of any of claims 1-6, wherein the access device is a wireless device.

8. The method of claim 7, wherein the access device is selected from the group consisting of a pager device and a PDA (personal data assistant).

9. The method of claim 7, wherein the access device is a cellular telephone and wherein the access network is a cellular telephone network.

10. The method of claim 9, wherein the resource is accessed through a data session with said cellular telephone.

11. The method of claim 10, wherein the resource is a mark-up language page.

12. The method of claim 11, wherein said mark-up language page is a WML (wireless mark-up language) page.

13. The method of any of claims 9-12, wherein said request is sent according to a string.

14. The method of claim 13, wherein said string is resolved by parsing said string, such that at least a portion of said string identifies an address for the resource.

15. The method of claim 14, wherein said address for the resource is a server for parsing at least a portion of said string to identify the resource.

16. The method of any of claims 13-15, wherein said string includes a telephone number.

17. The method of claim 16, wherein said string is parsed according to global title translation.

18. The method of claims 16 or 17, wherein said request includes a voice message.

19. The method of any of claims 9-15, wherein said request is sent according to USSD (unstructured supplementary services data) format.

20. The method of any of claims 9-15, wherein said request is sent according to SMS (short message service) format.

21. The method of claim 1, wherein the access network is selected from the group consisting of PSTN (public switched telephone network) and ISDN.
